(19) United States
(12) Patent Application Publication
(10) Pub. No.: US 2005/0271110 A1
(43) Pub. Date: Dec. 8, 2005

(54) Excimer laser system with stable beam output

(76) Inventors: Rainer Paetzel, Dransfeld (DE); Thomas Schmidt, Kupphausen (DE); Michael Gehrke, Kalefeld (DE); Hans-Stephan Albrecht, Goettingen (DE); Kay Zimmerman, Bovenden (DE); Phil Dekker, Almelo (NL); Syb Leijenaar, Hengelo (NL)

Correspondence Address: STALLMAN & POLLOCK LLP, SUITE 2200, 353 SACRAMENTO STREET, SAN FRANCISCO, CA, 94111, US

(21) Appl. No.: 11/176,479

(22) Filed: Jul. 7, 2005

Related U.S. Application Data
(63) Continuation-in-part of application No. 10/645,947, filed on Aug. 22, 2003.
(60) Provisional application No. 60/586,569, filed on Jul. 9, 2004.

(51) Int. Cl. H01S 3/22; H01S 3/223; H01S 3/03

(52) U.S. Cl. 372/65; 372/57

(57) ABSTRACT

An excimer master-oscillator-power amplifier (MOPA) system includes two laser discharge units (LDUs). Optical modules are associated the LDUs for forming the master oscillator and the power amplifier. The discharge units are each assembled onto a chassis via a vibration-damping suspension. The optical modules are assembled on a frame that is separately attached to the chassis. Providing the separate frame for optical modules, mechanically isolated from the LDUs because of the vibration isolating suspension, minimizes transmission of vibrations from the LDUs to the optics modules.

### CROSS REFERENCE TO PRIOR APPLICATIONS

The instant application is a continuation-in-part of U.S. patent application Ser. No. 10/645,947, filed Aug. 22, 2003. The instant application also claims the priority of U.S. Provisional Application No. 60/586,569, filed Jul. 9, 2004.

### TECHNICAL FIELD OF THE INVENTION

The present invention relates in general to the assembly of excimer laser systems including at least one laser discharge unit and optical modules for forming a resonator, and delivering an output beam for the laser. The invention relates in particular to an assembly in which the laser discharge unit and the optical modules are mechanically isolated from each other.

### DISCUSSION OF BACKGROUND ART

An excimer or molecular fluorine (F₂) laser system includes at least one laser discharge unit (LDU). The laser discharge unit includes a laser chamber including a laser gas mixture, discharge electrodes across which a discharge is repeatedly fired by application of a high potential across the electrodes, and a fan for circulating the laser gas mixture through a gap between the electrodes in which the discharge occurs. The LDU also includes pulse generating electronics, mounted on the laser chamber, for generating the high potential as a plurality of electrical pulses.

The excimer laser system usually includes optical modules arranged in cooperation with the laser chamber of the LDU for forming an optical resonator; defining the exact operating wavelength of the laser within a range of wavelengths characteristic of the gas mixture; delivering a beam from the optical resonator; stretching optical pulses from the resonator; and providing beam diagnostics. The system includes power supplies for the discharge unit and for driving the fan, and other mechanical devices, for example, for cooling the LDU.

In a straightforward excimer laser there would be only one LDU, usually, however, there are two LDU's, one forming part of a master oscillator, and the other forming part of an optical amplifier or a power oscillator for amplifying the output of the master oscillator. Such systems are usually referred to as MOPA (master oscillator, power amplifer) systems or MOPO (master oscillator, power oscillator) systems.

Whatever the system, all of the above-discussed optical, mechanical, and electrical components are assembled onto a single main frame or chassis to form the system into an integrated unit. The chassis is usually covered with plates and the like to prevent accidental or unauthorized access to the components.

Mechanical devices such as electric motors and fans inevitably provide a source of mechanical vibration of the system chassis. Vibration can also result from electrical pulsing devices. Any of this vibration that is transmitted the LDU and the optics modules can adversely effect the performance of the laser system. Such effects can include instability of the lasing wavelength or the spectral width of the laser output, and instability of pointing (the general propagation direction of the laser beam.

In prior-art systems such vibration effects are reduced by mounting the LDU (or LDUs) and associated optics on sub-mount frame and assembling that frame onto the main frame or chassis via some kind of vibration-damping suspension such as rubber blocks or stiff metal springs. It has been determined however that certain applications of the output beam of such systems, such as optical lithography, laser micro-machining, or material processing, would benefit from even greater stability of beam parameters than is provided by prior-art system assembly arrangements.

### SUMMARY OF THE INVENTION

The present invention is directed to minimizing instability of parameters of a beam delivered by a laser system. In one aspect, a laser apparatus in accordance with the present invention comprises a laser chassis on which a laser system is to be assembled. A resilient suspension is connected to the chassis for supporting a laser discharge unit (LDU) of the laser. An optics frame is provided for supporting optical elements on the chassis, the optical elements being cooperative with the laser discharge unit for forming a laser resonator, and the optics frame being separate from the resilient suspension. The resilient suspension minimizes transmission of vibrations from the laser discharge unit to the chassis and accordingly to the optics frame supported on the chassis.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates one preferred embodiment of a laser system in accordance with the present invention including a laser chassis, an optics frame including tables for optical modules, and supported on the chassis, and two LDUs both supported on an LDU frame, the LDU frame being supported on the chassis via a vibration-damping suspension.

FIG. 1A is a three-dimensional view schematically illustrating a Cartesian X, Y, and Z-axis system, and torsional degrees-of-freedom R_{X}, R_{Y}, and R_{Z} corresponding to the X, Y, and Z-axes, respectively.

FIG. 2 is a three-dimensional view schematically illustrating one preferred example of a vibration-damping suspension for an LDU in the system of FIG. 1, including wheel assemblies attached to the LDU, a support structure for the LDU on which the wheel assemblies rest, and steel W-springs attached to the support structure and the chassis for vibration isolating the LDU from the chassis.

FIG. 3A is a plan view from above schematically illustrating details of the support structure and steel W-springs of FIG. 2.

FIG. 3B schematically illustrates details of a wheel in a wheel assembly of FIG. 2 supported on a transverse rail of the support structure of FIG. 2.

FIG. 3C schematically illustrates details of a steel W-spring in the suspension of FIGS. 2 and 3A.

FIGS. 3D and 3E are three-dimensional views schematically illustrating details of the steel W-springs attached to an end-stop bracket in the suspension of FIG. 2.

FIG. 3F is cross-section view seen generally in the direction 3F-3F of FIG. 3C, schematically illustrating details of connecting a steel W-spring to the LDU support structure and chassis of FIG. 2.

FIG. 4 is three-dimensional view schematically illustrating one example of a frame construction for the optics frame of FIG. 1.

FIG. 5 is three-dimensional view illustrating one example of a chassis construction for laser system of FIG. 1.

### DETAILED DESCRIPTION OF THE INVENTION

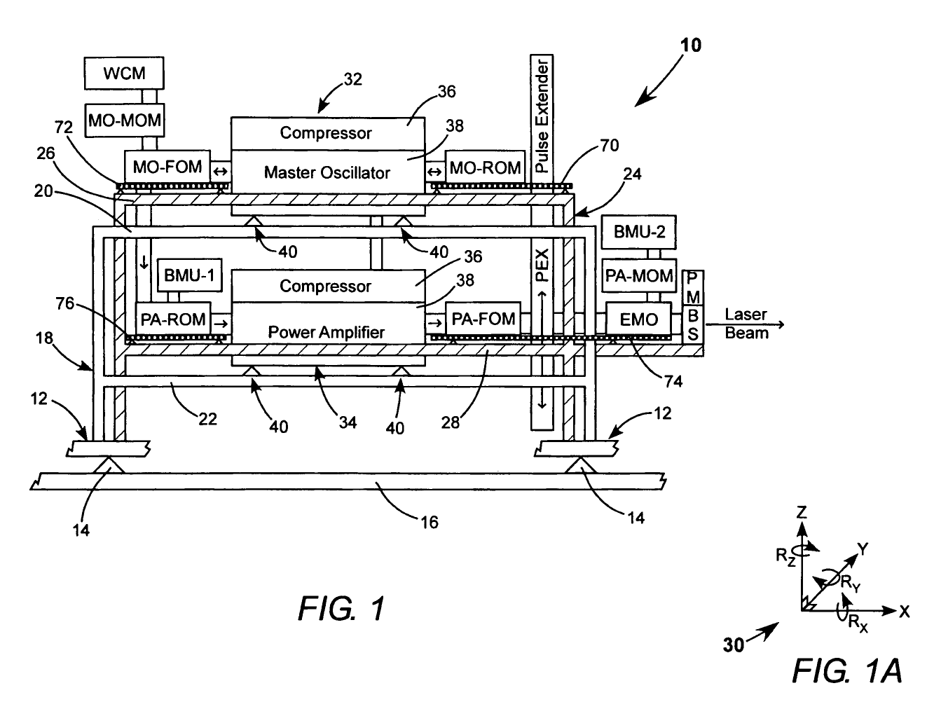

Referring now to the drawings, wherein like components are designated by like reference numerals, FIG. 1 schematically illustrates one preferred embodiment 10 of an excimer laser MOPA system in accordance with the present invention. Laser system 10 includes a laser chassis 12, designated only fragmentarily in FIG. 12 for convenience of illustration. Those skilled in the art will be aware that such a laser chassis is a single main frame, usually covered, on which all components of the laser system are assembled, one way or another. Here, chassis 12 rests on feet 14 in contact with a rigid floor 16. Floor 16 preferably is a concrete floor of a building.

In chassis 12 of MOPA 10, components are assembled on, or supported on, either a frame 18 having upper and lower levels 20 and 22, respectively, or a frame 24 having upper and lower levels 26 and 28, respectively. Frames 18 and 24 are depicted in FIG. 1 in a simplest form, for convenience of illustration. A practical example of such a frame is described in more detail further hereinbelow. FIG. 1A schematically illustrates a Cartesian axis system 30 of the MOPA to which reference is made frequently in the following description. Axis system 30 has the usual X, Y, and Z-axes. The Y-axis is a horizontal axis perpendicular to the plane of the drawing of FIG. 1. The X-axis and the Z-axis are respectively vertical and horizontal axes parallel to the plane of FIG. 1. A laser beam emitted by the system is emitted parallel to the X-axis. In the description of MOPA 10 set forth below reference is made to six degrees-of freedom (DOFs) of motion of chassis 12 that are variously controlled. Three of these DOFs are translations parallel to the X, Y, and Z-axes. The other three of these DOFs are torsions R_{X}, R_{Y}, and R_{z}, about the X, Y, and Z-axes, respectively.

MOPA 10 includes two laser discharge units (LDUs) 32 and 34, each thereof having an electrical-pulse compressor 36 surmounting a laser chamber 38. The pulse compressors receive a sequence of electrical pulses from a pulsed power supply (not shown), and electronically compress the pulses, thereby shortening the duration and increasing the peak power of the pulses. Laser chamber 38 includes a lasing gas, and electrodes (not shown) across which the sequence of compressed optical pulses are applied to strike a corresponding series of gas discharges in laser gas between the electrodes. Laser chamber 38 also contains a fan for circulating the laser gas between the electrodes.

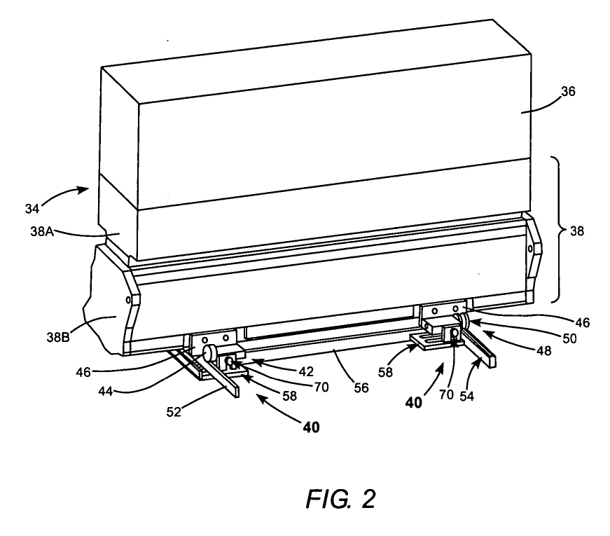

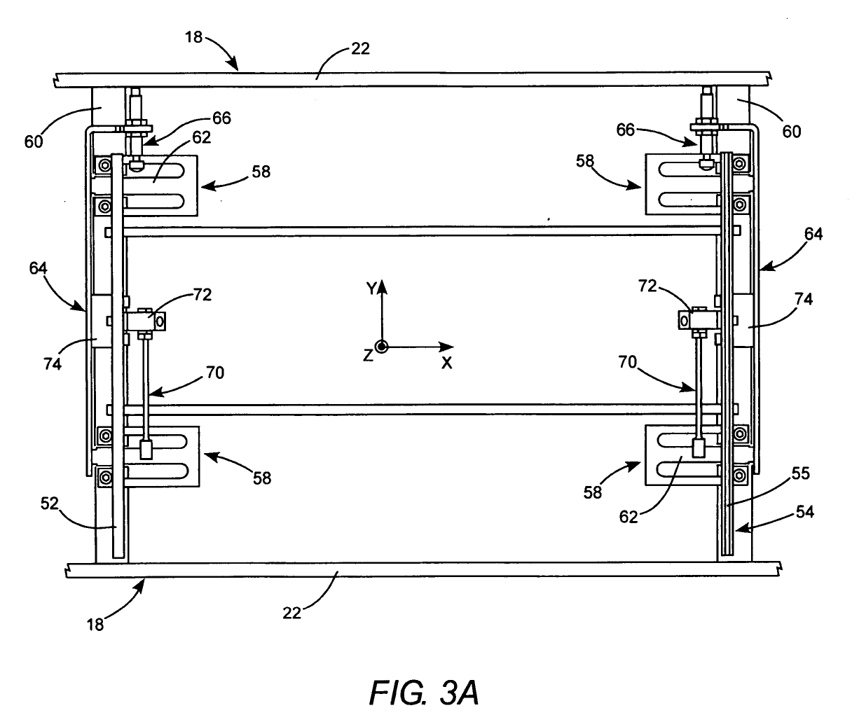

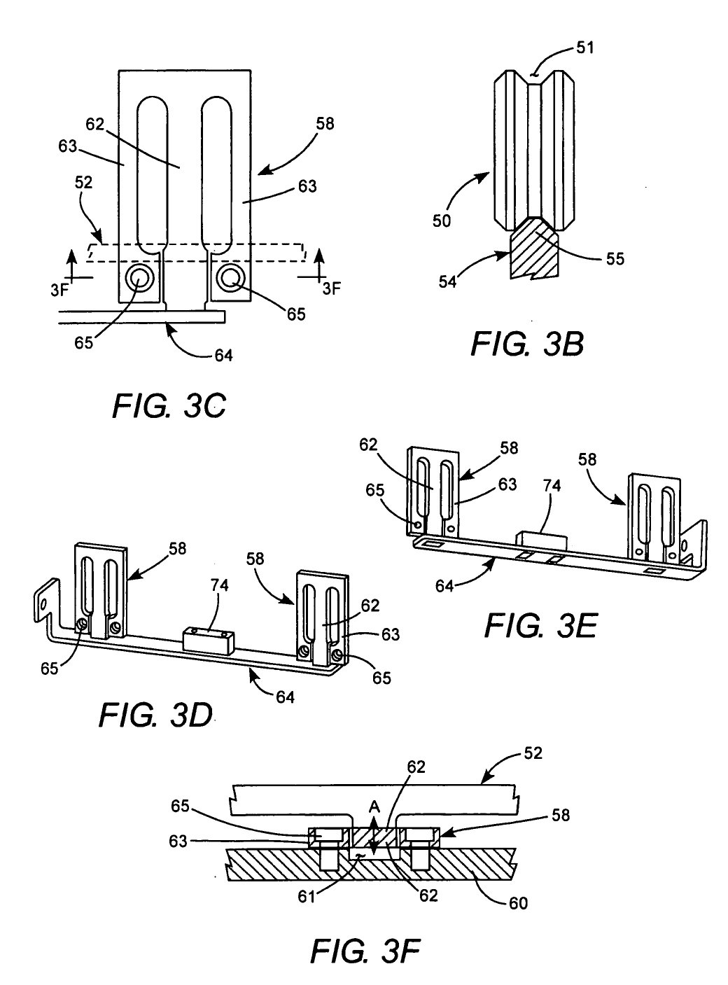

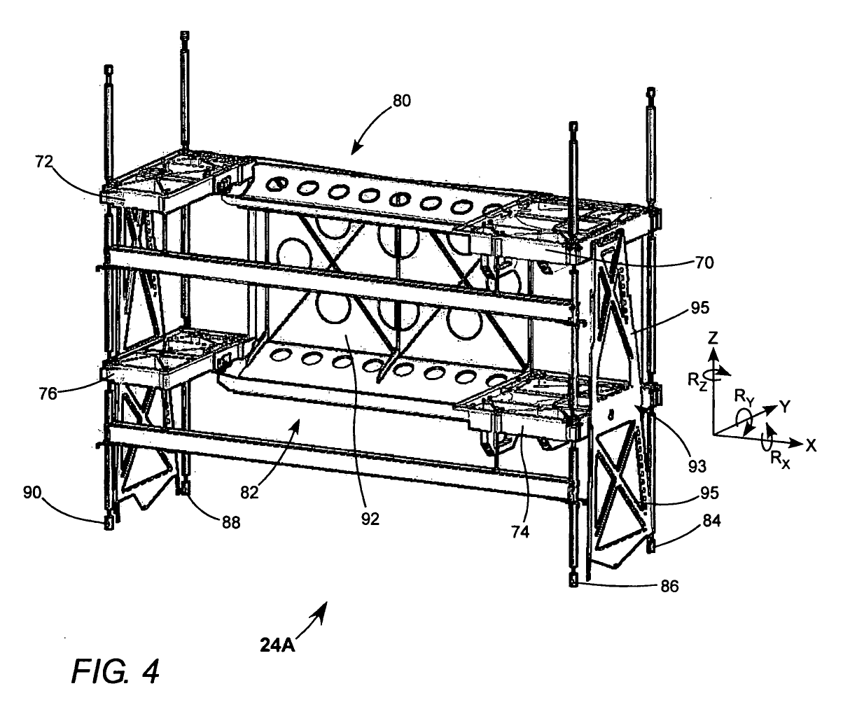

Each laser discharge unit is mounted on frame 18 via a resilient suspension. This suspension system is depicted without detail in FIG. 4 by triangles 40. The resilient suspension provides for vibration-isolating the laser discharge unit from frame 18 and, accordingly, the chassis. This in turn isolates frame 24 from vibrations produced by the LDU. The suspension system may be provided by something as simple as a rubber block mounting. It is preferable, however, that the suspension can be arranged to have different stiffness in different degrees of freedom. A brief description of one such suspension system is set forth below with reference to FIG. 2 and FIGS. 3A-F.

FIG. 2 schematically illustrates details of laser discharge unit 34 of FIG. 1 mounted on a preferred example of a suspension 40. Here, laser power amplifier 38 of laser discharge unit 34 has an upper chamber 38A, including discharge electrodes and pre-ionizing units (not shown). A lower chamber 38B includes a fan assembly arranged to circulate laser gas from the lower chamber, through the upper chamber, and back to the lower chamber. Suspension 40 includes a wheel assembly 42 including a wheel 44, and also a wheel assembly 48 including a wheel 50. The wheel assemblies are attached to a side of lower chamber 38B of the discharge unit via plates 46. There are corresponding wheel assemblies (not visible in FIG. 2) on the opposite side of the LDU providing a total of four wheel assemblies and four wheels.

Wheels 20 are supported on a Y-axis support member 52, and wheels 50 are supported on a Y-axis support member 54. FIG. 3B depicts further detail of Y-axis support member 54 and wheel 50, wherein it can be seen that the Y-axis support member includes an upper ridge 55 having a truncated V-shaped cross-section, and that wheel 50 has a corresponding, circumferential, truncated V-shaped groove. Y-axis support member 52 and 54 are connected by longitudinal tie members 56 the cross-members and are welded to steel W-springs 58, which are configured to be attached to frame 18.

FIG. 3A schematically depicts one preferred arrangement for attaching the Y-axis support member 52 and 54 to springs 58 and for attaching the springs to frame 18. Further details of the springs and the cross members are depicted in FIGS. 3C-F.

As depicted in FIG. 3A, frame 18 has transverse members 60 extending between longitudinal side-members 22 thereof. Transverse members 60 preferably have a channel section or the like to impart stiffness to the transverse members. Springs 58 are mounted under the Y-axis support members 52 and 54, and above a surface of transverse members 60. Springs 58 are attached to Y-axis support member 52 and to Y-axis support member 54, here, by welding. Only a center arm 62 of each spring 58 is welded to the Y-axis support members. LDU 34 can move on Y-axis support members 52 and 54 (see FIG. 2) via wheels 44 and 50.

Suspension 40 also includes end-stop brackets 64. End-stop brackets 64 are also attached to center arm 62 of springs 58. End stops 66 are coupled to the end stop brackets 64. End-stop faces 68 of end-stop 66 contact side member 22 of frame 18. The end stops are used for positioning the LDU 34 in the Y-direction. Differential screw assemblies 70 are used to adjust the LDU 34 positioning in the Y-direction. Differential screw assemblies 70 are fixed relative to the Y-axis support members 52 and 54 by holders 72. Holders 72 operate to couple the Y-axis support members to the end-stop brackets 64 via attachments 74 on the end-stop brackets. The differential screw assemblies interface with wheel assemblies 42 and 48 (see FIG. 2), such that as the differential screws are adjusted, the position of the wheel assembly (and the LDU) moves along the Y-axis support members.

The position accuracy of the LDU 34 relative to optics frame 24 is important. The position in Y-direction of the LDU 34 in regard to the optics frame can be determined by adjustable end stops 66 and similar adjustable end stops could also be mounted on the LDU itself. The position of the LDU in Z-direction is determined by the level or height of Y-axis support member 52 and Y-axis support member 54, and by the position of the diameter of the wheels 44 and 50 of wheel assemblies 42 and 48 (see FIG. 2). The X-axis position is determined by the position of Y-axis support member 54 and the wheels 50 that are positioned on Y-axis support member 54 (typically these would be v-grooved wheels as depicted in FIG. 3B). Springs 58 have no flexibility in the X-axis. For laser system 10 the Y- and Z-directions are of greatest importance.

FIGS. 3C and 3F schematically illustrate a preferred arrangement for mounting springs 58 to frame 18, here, via transverse member 60 of the frame 18. In this arrangement, outer arms 63 of each spring 58 are attached to frame member 60 via screws (not shown) inserted through countersunk holes 65. A relief slot 61 is provided in member 60 (see FIG. 3F) to allow travel of center arm 62 of spring 58 as indicated by double arrow A. Vibrational energy of components of the LDU 34 such as the fan, is dissipated by W-springs 58 so as to reduce vibrations imparted to the laser chassis via frame member 60. In this way, the W-springs provide a resilient coupling between the laser chassis and the LDU, which dissipates vibrational energy in the system. While this example of suspension 40 is described with reference to mounting LDU 34, the same suspension may be used for mounting LDU 32.

It should be noted here that the brief description of an example of suspension 40 is presented merely for completeness of description. Further details of this particular suspension are provided in published U.S. patent application No. 2004/0101018, the complete disclosure of which is hereby incorporated by reference. It should be further noted, however, that the present invention is not limited to this type of suspension. Those skilled in the art to which the present invention pertains may deploy a different type of suspension without departing from the spirit and scope of the present invention.

Referring again to FIGS. 1 and 1A, in laser system 10 the optical beam path is defined by modules that are mounted to four separate optical tables. These are designated as table 70 (upper-right), table 72 (upper-left), table 74 (lower-right) and table 76 (lower-left). Supported on table 70 is a master-oscillator-rear-optics module (MO-ROM). Supported on table 72 are a master-oscillator-front-optics module (MO-FOM), a master-oscillator-monitor-optics module (MO-MOM), and a wavelength-control module (WCM). Supported on table 74 are a power-amplifier-front-optics module (PA-FOM), an energy-monitor module (EMO), a power-amplifier-monitor-optics module (PA-MOM), and a beam-measuring unit (BMU-2). Supported on table 76 are a power-amplifier-rear-optics module (PA-ROM) and another beam-measuring unit (BMU-1). Other modules including a power-meter module (PM) and a beam-shutter module (BS) are supported directly on optics frame 24. An optical pulse expander (PEX) is supported directly on chassis 12. The optical modules are interconnected by tubes (not specifically designated) through which the beam passes, as indicated by single and double arrows, the double arrows indicating beam-circulation in a resonator. The resonator for master oscillator LDU 36 is formed between a grating in module (MO-ROM) and a partially transmitting mirror in module (MO-FOM).

It should be noted that the many modules depicted in FIG. 1 are depicted and described herein merely for completeness of description. It is not necessary to include all such modules in a laser in accordance with the present invention. Usually, however, there would be at least one LDU and sufficient optics to form a resonator including that LDU.

The optics modules, and accordingly the optical tables, must be aligned and fixed in both relative and absolute position. The optical tables define the exact positions of the optical modules and, with that, the absolute and relative positions of the laser beam. Frame 24 that supports the optics tables and the optical modules may be designated as “the optical resonator structure” (ORS), and such terminology is used herein as an alternative designation for frame 24. The laser beam, as well as the position of the ORS, has to be referenced to any apparatus utilizing the laser beam, for example a laser wafer scanner (not shown). A beam delivery unit (not shown), which delivers the beam from the laser output to the wafer scanner, is referenced to the floor 16 in absolute position. The stiff and stable floor provides the reference for both laser system 10 and the wafer scanner. Following this concept, the ORS (frame 24) has to provide the stable connection of the optic tables to the floor.

Three main error sources for a stable position of the optics tables can be distinguished. These are deflections caused by static loads, deflections caused by vibrations, and deflections caused by temperature gradients. An ORS that is able to fit the stability requirements of the present invention and can cope with the different error sources has been designed in a way that all six degrees of freedom (DOFs) are fixed only one time each. A high stiffness is important to meet the requirements. All mounts, structural elements or assemblies are designed such that all six degrees of freedom are singly constrained. This assures that movement will be prevented, while stress will not be introduced into the structure.

Prior-art methods for fixing degrees of freedom in mounting of an optics platform are typically based on a kinematic (three-point support) mount for the platform. Such mounts may be variously configured with respect to the three support- points. By way of example, in a first configuration, three balls are provided engaging three V-shaped grooves. In this configuration, each ball fixes two DOFs. In a second configuration there is a first ball engaging a hole and fixing three DOFs; a second ball engaging a plane surface and fixing 1 DOF; and a third ball engaging a V-shaped groove and fixing 2 DOFs.

For the first configuration, the thermal centre lies in the (virtual) heart of the V-shaped grooves. For the second configuration, the ball in the hole determines the thermal centre.

For inventive laser system 10, the above-described traditional kinematic mount appeared to be not suitable for supporting frame 24 on chassis 12 because of the geometry requirements of the frame. For a kinematic mount, a basic requirement is that the body being supported must be rigid. Given the geometry and size of the ORS, such a rigid body structure, while not impossible to design, could not be economically built because of a demanding combination of material and space requirements. For frame 24 (the ORS) a convenient way of achieving a stiff structure that is fixed to its specified DOFs is to use a combination of stiff and elastic elements connected (indirectly, via chassis 12) to the rigid floor. In this way the rigidity of the floor helps to achieve a stable positioning of the ORS and the optical tables attached thereto. Trying to achieve the same frame rigidity without help of the rigidity of the floor would require a lot more material, for example, approximately 5 to 10 times more. A description of the design of one preferred example 24A of such a frame 24 is set forth below with reference to FIG. 4, wherein the axis system of FIG. 1A is included to facilitate the description.

The basis for the optical resonator structure design is a frame that connects the four optics tables. On both ends, the two opposite optics tables, i.e., tables 70 and 72, and tables 74 and 76, are connected rigidly together in six DOFs, to effectively form two sub-assemblies 80 and 82. The two sub-assemblies are connected rigidly to each other in five DOFs. Only torsion around the X-axis is kept weak in the connecting structure. This is necessary because the whole ORS is placed on four adjustable feet, 84, 86, 88, and 90, on the outer edges of the frame. The four feet are rigidly connected, via chassis 12 (not shown in FIG. 4) to the floor. In this way, the four edges of the frame 24A can be regarded as rigid in the Z-direction. By adjusting the feet in the Z-direction the frame can be leveled in the X and Y-axes. Because of the X-axis torsional weakness of frame 24A around the X-axis, all four feet will remain in contact with the chassis while being adjusted.

To cope with differential thermal expansion between the frame and the chassis, two feet 84 and 86 at the right hand end of the frame are made stiff in X-direction. The left hand end feet 88 and 90 can deflect easily in both X and Y. This provides that thermal centre of frame 24A in the X-direction is at the right-hand-end feet position, and also provides that the DOF of the frame in the X-direction is fixed. In the Y-direction, all four feet can deflect. Here, are at each end, a plate 93 cut-out to leave “bow-tie” stiffening structures 95, is used to connect the optics frame via the chassis to the floor. The plates are shaped in such a way that the middle of the LDUs on frame 18 is aligned to an optical axis defined by the optical modules. Because of this, the thermal centre in Y-direction will lie on this optical axis. The two plates fix the Y-direction of the optics frame and the rotation around the Z-axis. Since the four feet fix the Z-direction and the torsion around the Y-axis and X-axis, the whole frame position is fixed.

Because in frame 24A the four feet, 84, 86, 88, and 90 are required to fix 3 DOFs, the torsional weakness in the frame about the X-axis (R_{X}) is necessary to achieve a determined fixation of the frame, via the chassis, to the floor. The R_{X} torsional weakness of the optics frame should be limited, however, to allow the frame to be transported separately and safely. Connections between the four optical tables have to provide, given the available space and accessibility constraints, as much as possible a high stiffness for rotational (torsional) movements of the tables. Translations are considered less critical. Frame deflections at Eigen-frequencies should cause mainly translational aberrations. This is achieved by connecting the optical tables in a kind of parallelogram. Opposite tables are made torsionally stiff by connecting the table together through a box section 92 on the back of the frame. Torsional stiffness of the tables is needed to keep the deflection within the system requirements. Main parts of frame 24 are preferably made from stainless steel with low expansion co-efficient, for example, INVAR or SUPER INVAR.

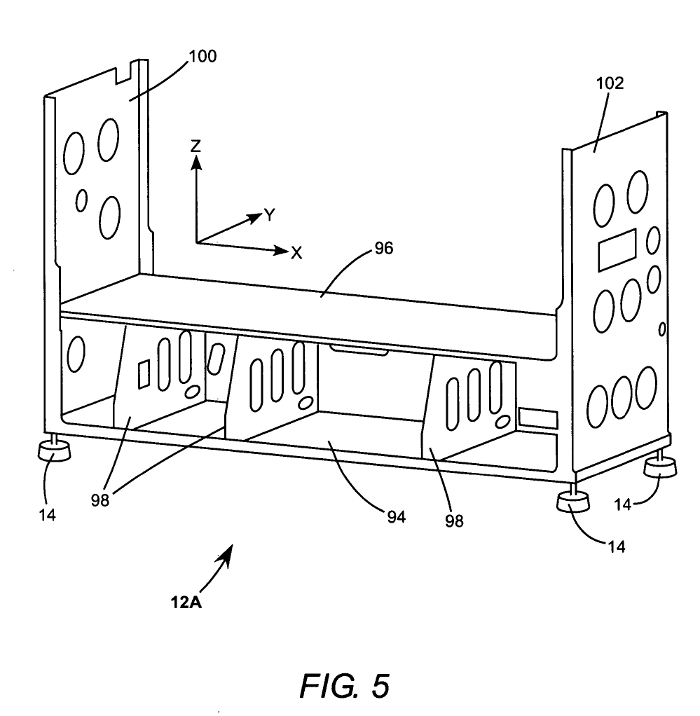

FIG. 5 schematically illustrates one example 12A of a chassis arrangement suitable for a laser in accordance with the invention. The terminology “laser chassis” as used by practitioners of the excimer laser art usually refers to an overall housing or structure for an excimer laser system. Typically, the laser chassis would hold one or more laser discharge units, support optics modules, power supplies, computer controllers and other elements which are necessary for the overall operation of the laser system. Covers are typically provided to prevent accidental or unauthorized access to components assembled on the chassis. Such covers are not shown in FIG. 5 to allow details of the chassis construction to be seen.

Chassis 12A has a base 94 and a pedestal 96. Bulkheads 98 connect the base and the pedestal to form a stiff stable platform for the two separated frames, i.e., frame 18 (see FIG. 1) supporting LDUs 34 and 32, which frame can be designated the pedestal frame, and optics frame 24, referred to herein also as the ORS. Attached to this platform are left and right end-walls 100 and 102, respectively. Spaces between bulkheads 98 are used to accommodate, power supplies, gas units, cooling units, purge units electronics, and the like. The chassis is supported on feet 14 corresponding to feet 14 of FIG. 1. It is to be noted that in chassis 12A pedestal 96 would correspond to fraction portions 12 of the chassis of system 10 of FIG. 1.

Those skilled in the art will recognize that while frame 18 is described above as being a unit separate from chassis 12 it is possible to make that frame an integral part of chassis 12 or 12A, i.e., with the chassis itself being the frame on which the LDUs are supported. In accordance with the present invention, however, the LDUs must still be supported on the chassis via a vibration isolating suspension, which can be a steel W-spring type suspension as described above, or any other type of suspension. This is because such a suspension is required to isolate the separate ORS (frame 24 or 24A) and optical modules thereon from LDU vibrations that would be otherwise transmitted thereto, via the chassis, in the absence of a vibration isolating suspension.

The present invention is described above in terms of a preferred and other embodiments. From the description, those skilled in the art may devise, without undue experimentation, or without departing from the spirit or scope of the invention other embodiments. Such embodiments may include but not be limited to embodiments having a different chassis structure, with or without an integral frame for supporting one or more LDUs, a different separate optics frame, or a different vibration isolating suspension for the LDU or LDUs. All such embodiments or deviations should be construed to be within the scope of the claims appended hereto.

1. Laser apparatus, comprising:
a chassis for supporting a laser;
a resilient suspension connected to the chassis for supporting a laser discharge unit (LDU) of the laser;
an optics frame supported on the chassis, separate from the resilient suspension, for supporting optical elements cooperative with the LDU for forming a laser resonator; and
wherein the resilient suspension minimizes transmission of vibrations from the LDU to the chassis and accordingly to the optics frame separately supported on the chassis.

2. The apparatus of claim 1, wherein the resilient suspension is connected directly to the chassis.

3. The apparatus of claim 1, wherein the resilient suspension is connected to the chassis via an LDU frame supported on the chassis.

4. The apparatus of claim 1, wherein the optics frame is supported at four points thereon on the chassis.

5. The apparatus of claim 4, wherein the apparatus can be characterized as having mutually perpendicular X, Y and Z, axes, with the Z-axis defining the height direction, and the direction of a beam emitted from the laser resonator being parallel to the X-axis, and wherein the frame as a whole has a sufficiently small resistance to torsion about the X-axis that the four support points of the frame are always in contact with the chassis.

6. The apparatus of claim 5, wherein there are first and second optics tables for supporting the resonator elements attached to the frame at first and second ends thereof, with the tables and frame being configured such that the tables form a sub-assembly thereof that is stiffened against translation in the X, Y, and Z-axes and against torsion about the X, Y and Z-axes.

7. The apparatus of claim 6, wherein there is a foot at each of the four support points of the frame with the feet being adjustable in the Z-axis for leveling the frame in the X and Y axes.

8. The apparatus of claim 7, wherein two of the four feet at one end of the frame can flex in the X-and Y-axis, and two of the four feet at the other end of the frame can flex in the Y-axis but are stiffened against flexure in the X-axis, thereby stiffening the connection of the frame to the chassis against translation in the X-axis while allowing sufficient overall flexure to accommodate differential thermal expansion and contraction between the frame and the chassis.

9. The apparatus of claim 1, wherein the resilient suspension includes first and second rails for supporting the LDU and first, second, third, and fourth steel springs, each thereof having three parallel arms, and, wherein an outer two of the arms of each spring is connected to the chassis, with the third arm of the first and second springs being connected to the first rail, and the third arm of the third and fourth springs being connected to the second rail.

10. The apparatus of claim 9, wherein the first and second a rails are parallel to each other and parallel to the Y-axis.

11. The apparatus of claim 10, wherein the LDU to be supported has four wheel assemblies attached thereto, each of the assemblies including a wheel, and wherein the first rail is arranged to contact two of the four wheels and the second rail is arranged to contact the other two of the wheels.

12. The apparatus of claim 11, wherein the suspension includes at least one screw assembly arranged to engage at least one of the wheel assemblies for adjusting the Y-axis position of the LDU.

13. The apparatus of claim 1, wherein the chassis includes two end-members having a pedestal structure therebetween and including a pedestal platform, and wherein the frame is supported on the pedestal platform of the chassis.

14. The apparatus of claim 13, wherein the optics frame is supported at four points thereon on the chassis.

15. The apparatus of claim 14, wherein the apparatus can be characterized as having mutually perpendicular X, Y, and Z, axes with the Z-axis defining the height direction, and the direction of a beam emitted from the laser resonator being parallel to the X-axis, and wherein the frame as a whole has a sufficiently small resistance to torsion about the X-axis that the four support points of the frame are always in contact with the chassis.

16. The apparatus of claim 15, wherein there are first and second optics tables for supporting the resonator elements attached to the frame at first and second ends thereof, with the tables and frame being configured such that the tables form a sub-assembly thereof that is stiffened against translation in the X, Y, and Z-axes and against torsion about the X, Y and Z-axes.

17. Laser apparatus, comprising:
a master oscillator and an amplifier, the master oscillator including a first laser discharge unit (LDU) and the amplifier including a second LDU;
first and second resilient suspensions connected to the chassis for supporting a respectively the first and second LDUs;
an optics frame supported on the chassis, separate from the resilient suspensions, supporting first modules cooperative with the first LDU and forming the master oscillator, and supporting second optical modules cooperative with second LDU and forming the amplifier; and wherein
the resilient suspensions minimize transmission of vibrations from the LDUs to the chassis and, accordingly, to the optics frame separately supported on the chassis.

18. The apparatus of claim 17, wherein the apparatus can be characterized as having mutually perpendicular X, Y, and Z, axes with the Z-axis defining the height direction, and the direction of a beam emitted form the laser resonator being parallel to the X-axis, and wherein the frame as a whole has a sufficiently small resistance to torsion about the X-axis that the four support points of the frame are always in contact with the chassis.

19. The apparatus of claim 18, wherein there are first and second optics tables for optics modules of the master oscillator and third and fourth optics tables supporting optics modules of the amplifier, the first and second optics tables being attached to the frame at first and second opposite ends thereof with the tables and frame being configured such that the tables form a first sub-assembly of the frame, the third and fourth optics tables being attached to respectively the first and second ends of the frame to form a second sub-assembly the frame, the first and second sub-assemblies being stiffened to resist translation in the X, Y, and Z-axes and torsion about the X, Y and Z-axes.

20. The apparatus of claim 19, wherein there is a foot at each of the four support points of the frame with the feet being adjustable in the Z-axis for leveling the frame in the X and Y axes.

21. The apparatus of claim 7, wherein two of the four feet at one end of the frame can flex and the X-and Y-axis, and two of the four feet at the other end of the frame can flex in the Y-axis but are stiffened against flexure in the X-axis, thereby stiffening the connection of the frame to the chassis against translation in the X-axis while allowing sufficient overall flexure to accommodate differential thermal expansion and contraction between the frame and the chassis.
